(19) United States
(12) Patent Application Publication
(10) Pub. No.: US 2015/0178030 A1
(43) Pub. Date: Jun. 25, 2015

(54) NETWORK DEVICE, CONTROL METHOD FOR NETWORK DEVICE, AND STORAGE MEDIUM THEREOF

(71) Applicant: CANON KABUSHIKI KAISHA, Tokyo (JP)

(72) Inventor: Kimito Kasahara, Yokohama-shi (JP)

(21) Appl. No.: 14/567,442

(22) Filed: Dec. 11, 2014

(30) Foreign Application Priority Data
Dec. 24, 2013 (JP) 2013-266028

(51) Int. Cl. G06F 3/12; H04N 1/00

(52) U.S. Cl. CPC G06F 3/1268; G06F 3/1294; G06F 3/1205; H04N 1/00244; H04N 2201/0094

(57) ABSTRACT

A network device communicates with a management server for managing master data of a setting value to be set in a plurality of network devices. The network device includes a receiving unit configured to receive an instruction for a change of the setting value; a storing unit configured to store a job in a memory unit; an executing unit configured to execute the change of the setting value in response to a success of the storage of the job; a request unit configured to request the management server to modify and reflect the change of the setting value; and a notifying unit configured to notify the completion of the change of the setting value without waiting for a response from the management server in response to the completion of the change of the setting value by the executing unit.

### BACKGROUND OF THE INVENTION

1. Field of the Invention

The present invention relates to a network device, a control method for the network device, and a storage medium thereof.

2. Description of the Related Art

In recent years, with respect to a setting value of an information processing device such as a multifunction device (network device), there are cases in which master data of the setting value is stored in a different information processing device such as a management server that is connected to a network and integrally managed. Their values are synchronized, and when the value of the master data on the management server is changed, the changed value is notified to the multifunction device and then the setting value in the multifunction device is also changed. Similarly, when the value of the setting value in the multifunction device is changed, the setting value of the master data on the management server is also changed. In addition, there are cases in which the values are synchronized between (among) a plurality of multifunction devices depending on the setting value, and when the value of the setting value is changed, the value of the setting value in the master data and the values of the setting values in all the multifunction devices that are subject to the synchronization are changed.

In a case where a user changes the setting value of the multifunction device, it is necessary to transmit the change of the setting value to the management server as soon as possible, in order to maintain the setting value during a failure of the multifunction device and in order to prevent inconsistencies in the values when the values are synchronized by the multifunction devices. At this time, if a communication to the management server is performed as an extension of a change operation of the setting value by the user, a disadvantage may be caused by constraining the time of the user over a long period until the completion of the communication in a case where, for example, the management server is physically located in a distant place. Accordingly, Japanese Patent Laid-Open No. 2002-84387 discloses a technique for reducing a waiting time of the user by performing a response of a process before all the processes requested from the user are completed and allowing the receipt of another job.

However, in the Japanese Patent Laid-Open No. 2002-84387, the user can utilize an outcome of the process after all the actual processes have been performed. Therefore, the change of the setting value in the multifunction device must be modified and reflected independently from the communication process to the management server because the setting values for changing the operation of the multifunction device itself are included. For example, if the setting value relating to a total printing function of the multifunction device is changed, the communication to the management server takes a long time, and the change of the setting value of the multifunction device itself is not modified and reflected until the completion of the communication, the contents of the setting change are not modified and reflected in the printing during the period, and as a result, disadvantages to the user may be caused.

### SUMMARY OF THE INVENTION

The present invention provides a network device that enables utilizing a changed setting value in a case where a request for changing the setting value is accepted from a user or the like, and promptly synchronizes the setting value regardless of a communication state with a management server.

According to an embodiment of the present invention, a network device communicating with a management server for managing master data of a setting value to be set in a plurality of network devices is provided that includes a receiving unit configured to receive an instruction for a change of the setting value; a storing unit configured to store a job generated for changing the setting value in a memory unit; an executing unit configured to execute the change of the setting value according to the stored job in a database managed by the network device in response to a success of the storage of the job in the memory unit; a request unit configured to request the management server to modify and reflect the change of the setting value according to the stored job in the master data, in a case where the job is stored in the memory unit; and a notifying unit configured to notify the completion of the change of the setting value without waiting for a response from the management server based on the request in response to the completion of the change of the setting value by the executing unit.

According to the present invention, a network device for enabling utilizing the changed setting value in the case where the network device accepts the request for changing the setting value, and for promptly synchronizing the setting value regardless of the communication state with the management server can be provided.

Further features of the present invention will become apparent from the following description of exemplary embodiments (with reference to the attached drawings).

### BRIEF DESCRIPTION OF THE DRAWINGS

FIG. 1 is a diagram illustrating a system configuration diagram illustrating an entire setting value synchronization system.

FIG. 2 is a block diagram illustrating a configuration of a management server.

FIG. 3 is a block diagram illustrating a configuration of a multifunction device.

FIG. 4 is a block diagram illustrating a configuration of master data managed at a setting value management server.

FIGS. 5A to 5D are diagrams illustrating configurations of database included in the master data.

FIG. 6 is a diagram illustrating configuration of a setting value DB stored in a HDD of the multifunction device.

FIGS. 7A and 7B are flowcharts illustrating a processing of the multifunction device.

FIG. 8 is a diagram illustrating one example of an edit screen of the setting value displayed on an operation unit by the multifunction device.

FIG. 9 is a block diagram illustrating a configuration of the master data managed at the setting value management server.

FIGS. 10A and 10B are diagrams illustrating configurations of the database included in the master data.

### DESCRIPTION OF THE EMBODIMENTS

Hereinafter, preferred embodiments of the present invention will be described with reference to the drawings and the like.

### First Embodiment

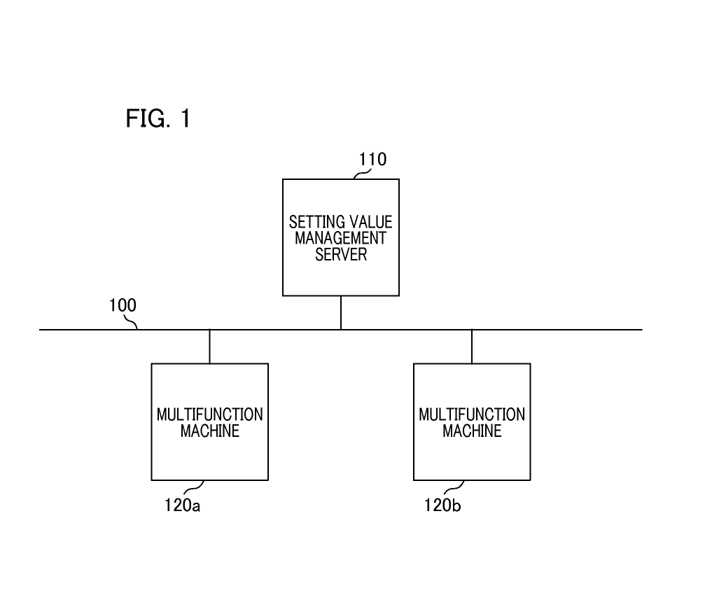

FIG. 1 is a diagram illustrating a system configuration of entire setting value synchronization system according to the present embodiment. A management server 110 and multifunction devices 120a and 120b are connected to a network 100. The management server 110 manages the master data of the setting value of the multifunction device 120a and the multifunction device 120b. If the master data is changed, the change information is notified to the multifunction device 120a and the multifunction device 120b through the network 100. In addition, if the change information of the setting value is received from the multifunction device 120a and the multifunction device 120b, the value of the master data of the management server 110 itself is changed.

The multifunction device 120 is a device (network device) for realizing a variety of functions (copy, FAX and the like), and internally stores the setting value, which is utilized if the functions are executed. If the setting value is changed, the change information is notified to the management server 110 via the network 100. In addition, if the change information of the master data of the setting value is received from the management server 110, the value of setting value of the multifunction device 120 itself is changed. The synchronization of the values may be performed between (among) the multifunction devices, for example, between the multifunction device 120a and the multifunction device 120b, depending on the setting value.

If the master data of the setting value on the management server 110 is changed, the change information of the setting value is notified to both of the multifunction device 120a and the multifunction device 120b. In addition, if the setting value of one of the multifunction device 120a and the multifunction device 120b is changed, the change information is firstly notified to the management server 110, and then the change information is secondly notified to the other multifunction device from the management server 110 via the network 100. The detailed description with respect to the management server 110 and the multifunction device 120 will be described below.

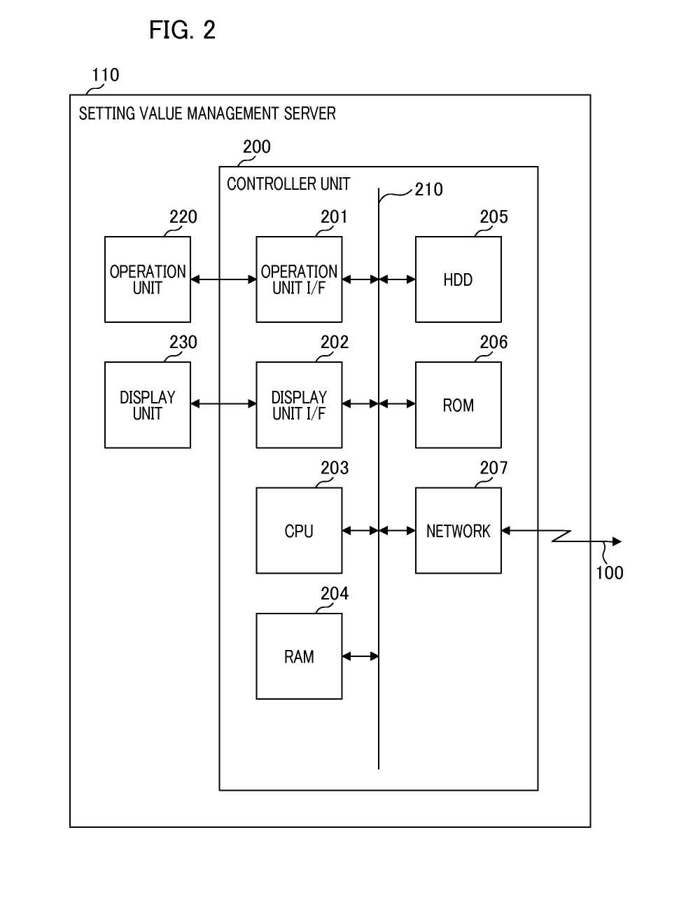

FIG. 2 is a block diagram illustrating a configuration of the management server 110 according to the present embodiment. The management server 110 includes a controller unit 200, an operation unit 220, and a display unit 230. The controller unit 200 has a CPU (Central Processing Unit) 203. The CPU 203 is a processor for controlling the entire system, and starts up an OS (Operating System) by a boot program stored in a ROM (Read Only Memory) 206.

The CPU 203 executes an application program that is stored in a HDD (Hard Disk Drive) 205, and executes various kinds of processes on the OS. A RAM (Random Access Memory) 204 is used for a work area of the CPU 203. The HDD 205 stores the application program and the master data of the setting value of the multifunction device 120a and 120b, and the like. The managing method of the master data will be described in detail below.

An operation unit I/F 201, a display unit I/F 202, and a network 207 are connected along with a ROM 206 and the RAM 204 to the CPU 203 through a system bus 210. The operation unit I/F 201 is an interface with the operation unit 220 configured by a mouse, a keyboard or the like, and transmits the information that is input by the user via the operation unit 220 to the CPU 203. The display unit I/F 202 outputs image data to be displayed on the display unit 230 comprising a display and the like to the display unit 230. Further, the Network 207 is connected to the network 100, and performs input/output of the information among each device on the network 100 through the network 100.

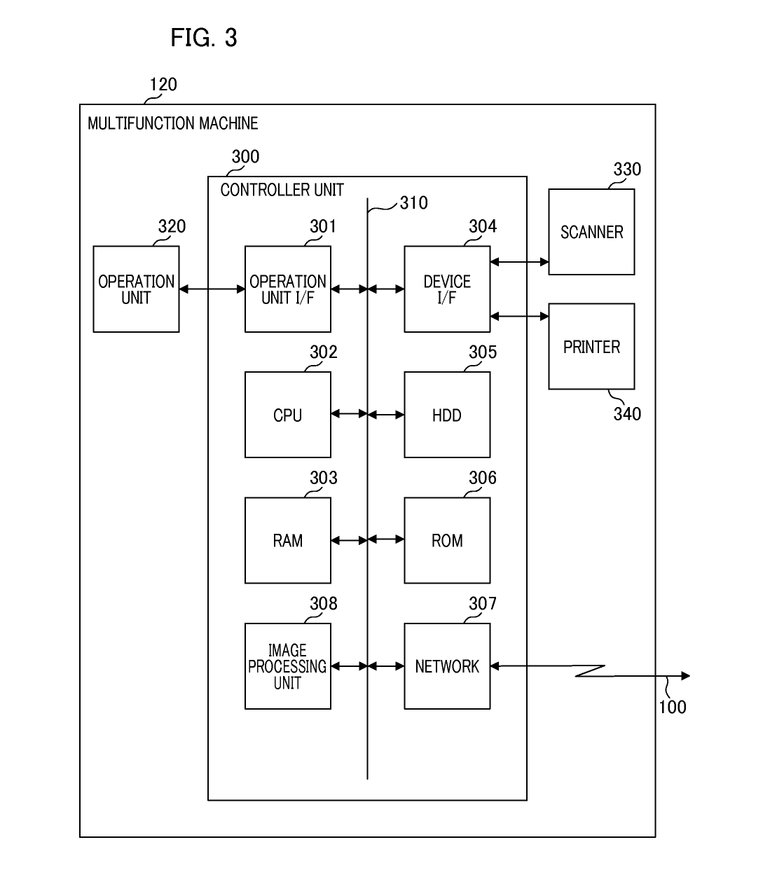

FIG. 3 is a block diagram illustrating a configuration of the multifunction device 120 according to the present embodiment. The multifunction device 120 includes a controller unit 300, an operation unit 320, a scanner 330, and a printer 340. The operation unit 320, the scanner 330 that is an image input device, and the printer 340 that is an image output device are respectively connected to the controller unit 300.

The controller unit 300 has the CPU 302, and the CPU 302 starts up the OS by the boot program stored in a ROM 306. The CPU 302 executes the application program stored in the HDD 305 and executes various kinds of processes on the OS. A RAM 303 is used for the work area of the CPU 302. In addition, the RAM 303 provides the work area, and provides an image memory area for temporarily storing the image data. The HDD 305 stores the application program, the image data and various kinds of the setting values. The managing method of the setting value in the multifunction device 120 will be described below.

An operation unit I/F 301, a device I/F 304, a Network 307, and an image processing unit 308 are connected to the CPU 302 with the ROM 306 and the RAM 303 through a system bus 310. The operation unit I/F 301 is an interface with the operation unit 320 having a touch panel, and outputs the image data to be displayed on the operation unit 320 to the operation unit 320. Further, the operation unit I/F 301 sends out the information that is input by the user via the operation unit 320, to the CPU 302.

The scanner 330 and the printer 340 are connected to the device I/F 304, and the device I/F 304 performs synchronous/asynchronous rewriting of the image data. The network 307 is connected to the network 100, and performs input/output of the information among each device on the network 100 through the network 100. In the image processing unit 308, the processes such as an input image process from the scanner, an output image process to the printer, image rotation, image compression, resolution rewriting, color space rewriting, gradation rewriting, and the like are performed.

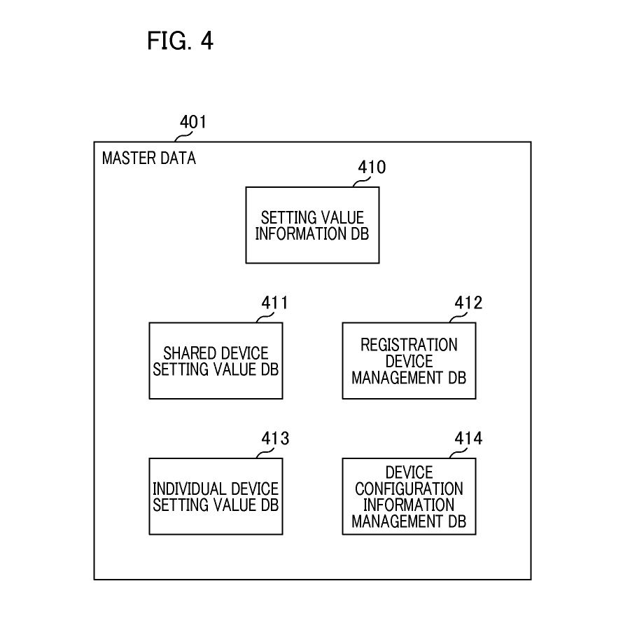

FIG. 4 is a block diagram illustrating a configuration of the master data managed at the management server 110 according to the present embodiment. Master data 401 is configured by a setting value information DB 410, a shared setting value DB 411, a device management DB 412, an individual setting value DB 413, and a configuration information management DB 414.

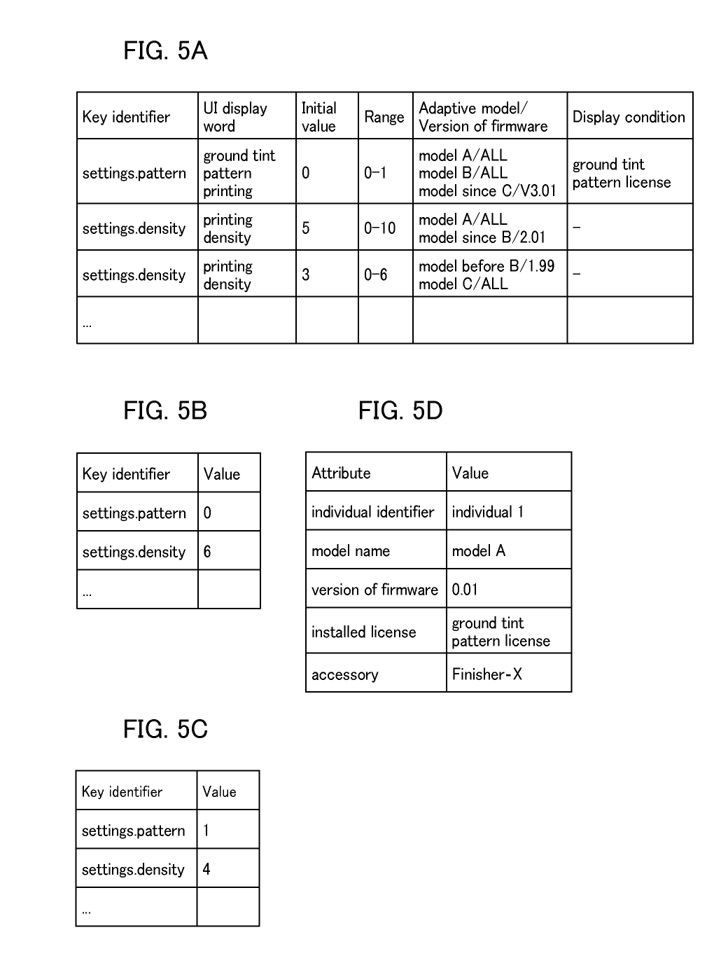

FIG. 5A is data stored in the setting value information DB 410. The setting value information DB 410 is a database for storing metadata relating to each setting value that is managed at the management server 110. A text that is being presented to the user, a key identifier for identifying the setting value when the communication with the multifunction device 120 is performed, an initial value, a range, an adaptive model/version, a display condition of the setting value are stored in the setting value information DB 410.

Each setting value managed at the setting value information DB 410 depends on the model of the multifunction device 120 and the version of the firmware, and therefore the range and the initialization value of the setting value may be different depending on the presence/absence of the setting value. In FIG. 5A, while the setting value representing the key identifier as “settings.pattern” exists in all the individuals in a model A and a model B, the setting value exists only in the individual since version 3.01 of the firmware in a model C. In addition, the setting value representing the key identifier as “settings.pattern” shows that the range and the initial value of the setting value are different depending on the installed version of the firmware in the model B.

FIG. 5B is data stored in the shared setting value DB 411. The shared setting value DB 411 is a database for managing the value of the setting value shared by all the multifunction devices 120 for managing the setting value by the management server 110. The key identifier and the value corresponding to the identifier are stored in the shared setting value DB 411. It is noted that, in the present embodiment, the key identifier is an identifier having a system that is the same as the key identifier of the setting value information DB 410.

FIG. 5C is data stored in the individual setting value DB 413. The individual setting value DB 413 is a database for managing the setting value whose values are different in each of the multifunction devices 120 for managing the setting value by the management server 110. It is noted that a plurality of the individual setting value DBs 413 exist in correspondence with the individual multifunction devices. The key identifier and the value corresponding to the identifier are stored in the individual setting value DB 413. The key identifier is an identifier having a system that is the same as the key identifier of the setting value information DB 410.

FIG. 5D is a diagram illustrating contents of the device configuration information of each individual of the multifunction device managed at the configuration information management DB 414. The configuration information management DB 414 is a database for storing and managing the device configuration information. The device configuration information includes an individual identifier for identifying the individual multifunction device 120, a model name, the version of the firmware, license information representing available functions, and the like. The model name, the version of the firmware, the license information and the like have a system that is same as the one stored in the setting value information DB 410.

The device management DB 412 is a database for managing the individual identifier of the individual multifunction device 120 for managing the setting value at the management server 110. The management server 110 is capable of collectively managing metadata of the setting value that is different in each of the multifunction devices 120 to be managed, the setting value that is shared by all the multifunction devices to be managed, and each setting value itself, by utilizing each database of the master data 401 described above.

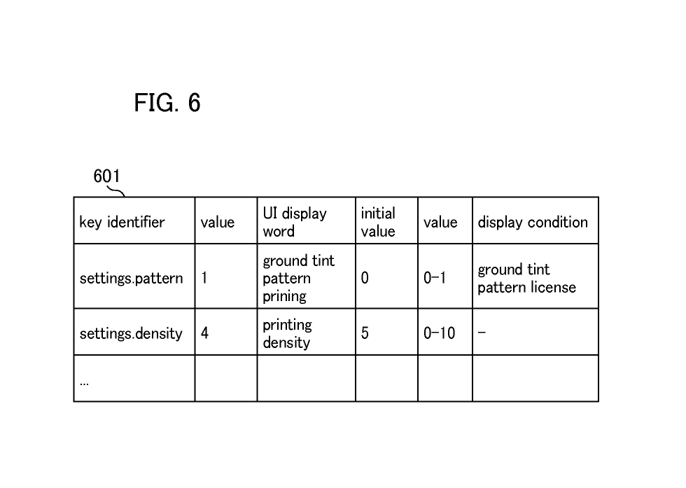

FIG. 6 is a diagram illustrating one example of a configuration of a setting value DB 601 stored in the HDD 305 of the multifunction device 120 according to the present embodiment. The setting value DB 601 is a database for storing the setting value used in the multifunction device 120. The setting value stored in the setting value DB 601 is configured by elements such as the key identifier for identifying the setting value, the value of the setting value, a UI display word, the initial value, the range, the display condition and the like. The elements are managed by the system that is same as the one managed by the master data 401. In a case where the setting value is changed at the management server 110 or the multifunction device 120, the setting value is synchronized by communicating at least the key identifier and the value in the data shown in FIG. 6.

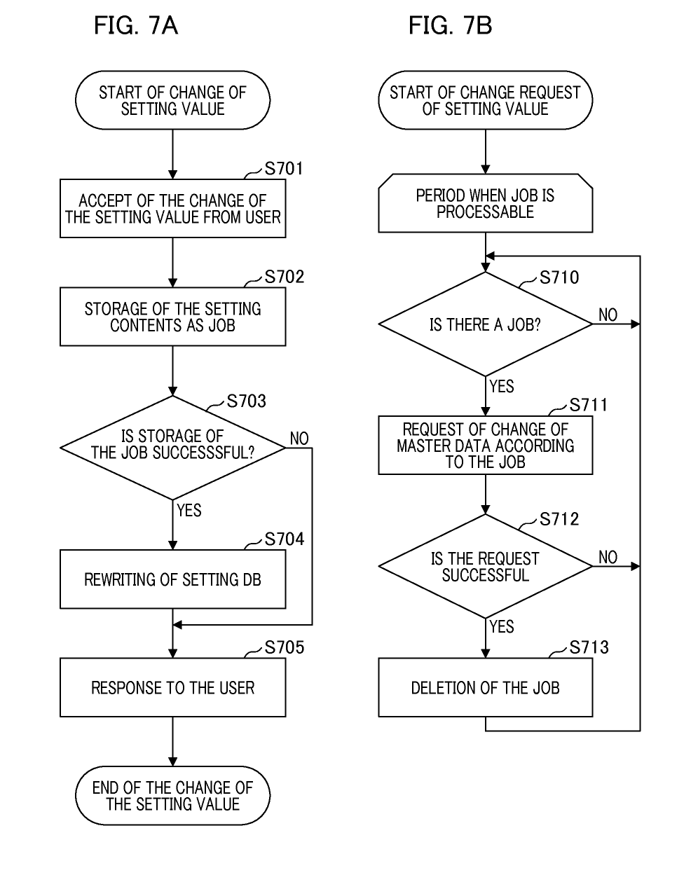

FIG. 7A is a flowchart illustrating one example of the processes executed by the multifunction device 120 if the user of the multifunction device 120 changes the setting value. The process is executed after the CPU 302 of the multifunction device 120 reads out the program from the HDD 305 and the program is expanded in the RAM 303. First, when an instruction for changing the setting value is accepted from the user, the multifunction device 120 displays the edit screen for the setting value on the operation unit 320 and accepts the changed contents of the setting value from the user (step S701).

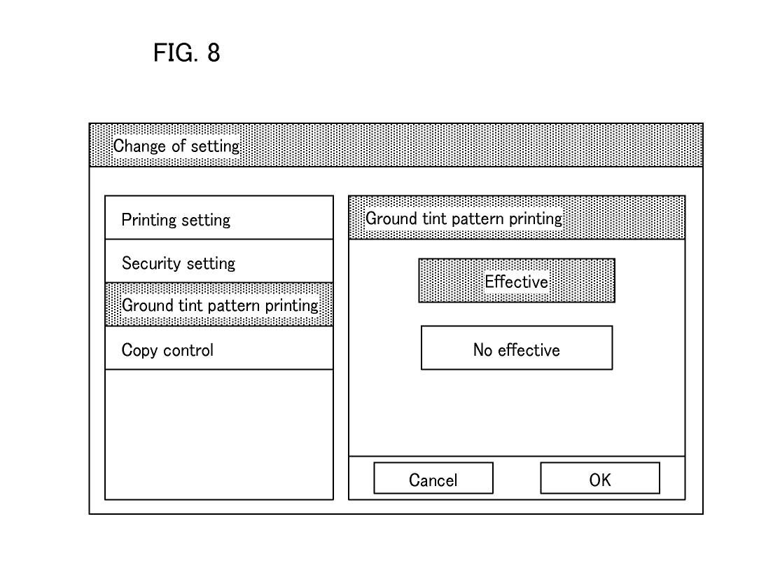

Here, FIG. 8 is a diagram illustrating one example of the edit screen for the setting value displayed on the operation unit 320 by the multifunction device 120 in step S701. FIG. 8 illustrates the screen for setting whether or not a ground tint pattern is enabled during printing. If an “OK” button is pressed after the user selects either of an “enable” button or a “do not enable” button, the CPU 302 determines the value after the change of the setting from the contents controlled by the operation unit 320.

In FIG. 7A, the multifunction device 120 generates the contents of the setting value instructed by the user as the job and stores them in order to allow referring the changed contents of the setting at a subsequent arbitrary timing (step S702). Specifically, the key identifier of the setting value after the change of the setting and the value after the change are treated as one pair, and they are stored as a file in a predetermined area in the HDD 305. The job is utilized when the change of the master data 401 of the management server 110 is subsequently requested. The details concerning the request process will be described below. If there is any other necessary information, for example, the data and the time when the change of the setting was received, the identifier of the user who performed the change of the setting, and the like, it may be simultaneously stored in the job.

Subsequently, the multifunction device 120 determines whether or not the job is stored in step S702 without causing any problems (step S703). If the storing of the job is successful (YES), the multifunction device 120 rewrites the contents in the setting value DB 601, which are stored in the HDD 305, in accordance with the job contents (step S704). Accordingly, it allows the user to utilize the changed setting value in the multifunction device 120. Finally, the multifunction device 120 updates the display of the operation unit 320 to an appropriate screen (step S705) and ends the process. That is, the completion of the change of the setting value is notified to the user.

In contrast, if the storing of the job is determined to be unsuccessful (failure) (NO) in step S703, the process proceeds to step S705. In step S705, the multifunction device 120 is not capable of subsequently transmitting the changed contents to the management server 110, and therefore the update of the screen is performed without rewriting the setting value DB 601 stored in the HDD 305, and the process is ended. Thereby, keeping the contents of the setting value DB 601 managed at the multifunction device 120 and the contents of the master data 401 managed at the management server in a synchronized state is allowed, even in a case in which the job cannot be stored due to, for example, a lack of area of the HDD 305 or the like.

FIG. 7B is a flowchart representing a process for requesting the change of the master data 401 to the management server 110 in accordance with the job contents stored in step S702 in FIG. 7A. In the process, the CPU 302 of the multifunction device 120 reads out the program from the HDD 305 and expands it to the RAM 303, and then the process is executed asynchronously and parallel with the process shown in FIG. 7A.

The multifunction device 120 loops the process explained below during which the job is processable, after the process is started. It is noted that the determination whether or not the job is processable may be arbitrarily performed, and the process time for the start-up and the end can be shortened by, for example, performing the determination that the job is not processable during the process for the start-up and the end of the multifunction device 120. Subsequently, the multifunction device 120 determines whether or not the file corresponding to the job is stored in the predetermined area in the HDD 305 (step S710). The process corresponds to the process that stores the changed contents of the setting value as the job in step S702.

If the job exists in step S710 (YES), the contents of the job are readout and the management server 110 is requested to change of the master data 401 along with the changed key identifier and the value (step S711). Here, it is contemplated that the changed contents is notified with, for example, HTTP (Hypertext Transfer Protocol) as a method for requesting the management server for the change, but other specific methods may be used if there are any other methods capable of communicating through the network.

Subsequently, the multifunction device 120 determines whether or not the request process performed in step S711 is successful (step S712). Concerning the specific determination method, it may be possible to determine from, for example, the availability of the connection to the server or the response contents of the server, and any other methods may be used if there are any other determinable methods. Accordingly, if the request process is determined to be successful in step S712 (YES), the multifunction device 120 deletes the file corresponding to the job that performed the request (step S713), and returns to the top of the loop.

In contrast, if the request process is determined to be unsuccessful (failed) in step S712 (NO), the multifunction device 120 returns to the top of the loop without deleting the file corresponding to the job, and retries the request of the job. Here, the process of step S711 is executed asynchronously and parallel with the process in FIG. 7A. Therefore, even if the communication with the management server is delayed due to network congestion or the like, the response process to the user is not delayed in step S705 and the waiting time of the user does not change.

It is noted that the method for detecting whether or not the file exists in the predetermined area in the HDD 305 is used in step S710, in the process shown in FIG. 7B, but the present invention is not limited to this, and any other methods may be employed. Conventionally, there has been contemplated a method, for example, for periodically searching all the setting value DB 601, extracting data different from the master data 401 and notifying the extracted data to the management server 110. However, in this method, it is necessary to periodically search the setting value DB 601 irrespective of whether or not the setting value is rewritten, and to collate it with the master data 401, and therefore the process efficiency may be decreased.

In contrast, in the method according to the present embodiment, the search and the collation of the database are not required for the determination whether or not the job exists, and therefore the process efficiency can be increased. It is noted that the job information is not necessarily stored in the HDD 305 as a file, and it may be stored, for example, in a predetermined area in the RAM 303. In this case, the predetermined area in the RAM 303 is confirmed in step S710.

In addition, it is possible to notify to the process in FIG. 7B about the storage of the job, by generating, for example, a signal or the like, if the storage of the job is successful in step S703, depending on the OS executed on the CPU 302. Accordingly, the asynchronous process can be performed without periodically confirming the contents in a folder by starting step S711 after the generation of the signal.

The present embodiment describes the case in which the user of the multifunction device 120 changes the setting value, and it may be possible to change the setting value of the multifunction device 120 by using a similar process even in a case in which the master data of the management server 110 has been changed. For example, the multifunction device 120 performs polling (inquiry) to the management server 110 as to whether the master data is periodically changed or not, and if the master data is changed, it may be possible to obtain the setting value corresponding to the change from the management server 110 and to modify and reflect it.

As described above, securely managing the setting values without increasing the waiting time of the user is made possible, by storing the changed contents if the multifunction device accepts the change of the setting by updating the setting value DB only in the case that the storing is successful, and by notifying to the management server asynchronously to this.

### Second Embodiment

In the first embodiment, the process in which the multifunction device 120 accepts the change of the setting value from the user is described. In recent years, in information processing devices such as the multifunction device and the like, there is a device that enables identifying each user and utilizing the preferred settings of each user if a plurality of users shares one device. For example, if one user often executes a monochrome printing and a two-sided printing, the settings are set by associating them with a specific button, and the user can execute the monochrome printing and the both sides printing only by pressing the button after the user logs in the device.

In such a device, the setting that is modified and reflected regardless of the user and the setting that is available by the specific user are not consistent. In the present embodiment, the setting value can be effectively managed between the management server and the multifunction device even in such a case.

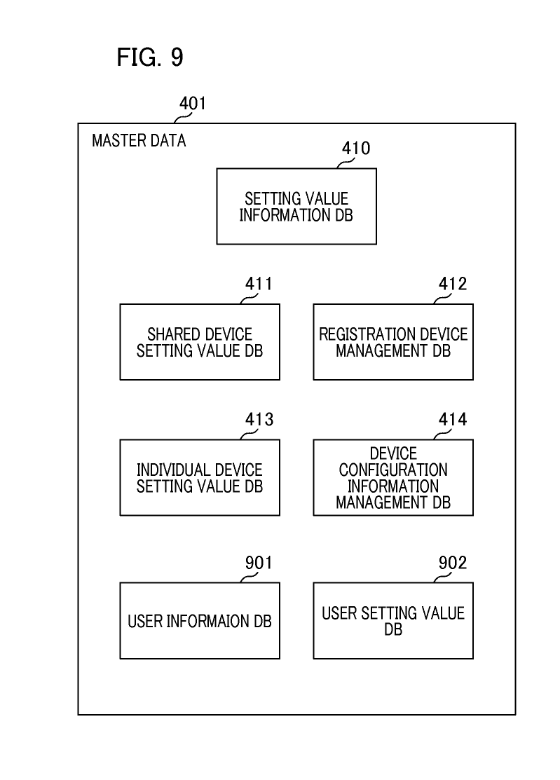

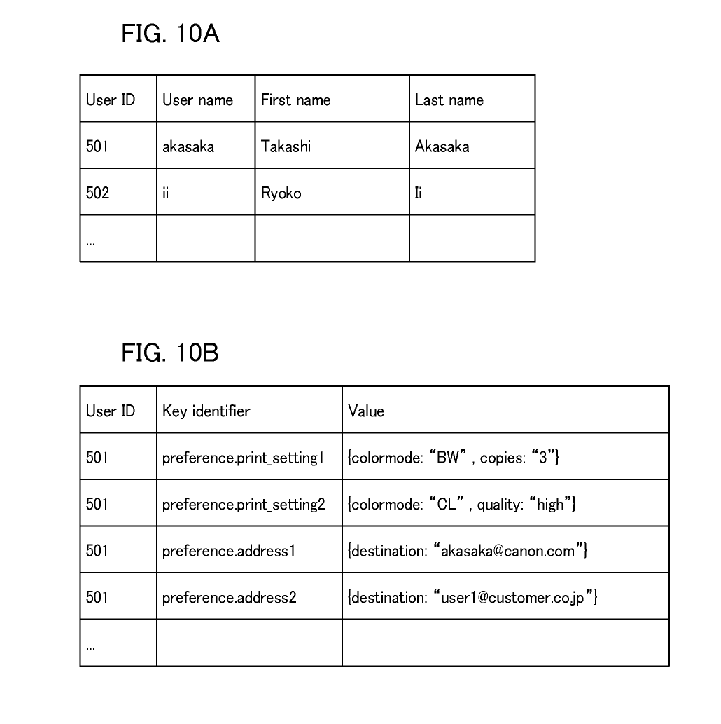

FIG. 9 is a block diagram illustrating a configuration of the master data 401 according to the present embodiment. In the present embodiment, user information DB 901 and a user setting value DB 902 are included in the master data 401 in order to manage the setting values of each user. FIG. 10A is data stored in the user information DB 901. The user information DB 901 is a database for managing the information relating to the user who utilizes the multifunction device 120. A user ID for uniquely identifying the user and a user name that is input by the user when the user logs in and the like are stored in the user information DB 901.

FIG. 10B is data stored in the user setting value DB 902. The user setting value DB 902 is a database for managing the setting values of each user, which is available by the user who utilizes the multifunction device 120. The user ID for uniquely identifying the user, the key identifier for uniquely identifying the setting values, and the contents of the setting value are stored in the user setting value DB 902. It is noted that this user ID has a system that is same as the one in the user information DB 901.

In the present embodiment, a database that is equivalent to the information DB 901 and the user setting value DB 902 is stored in the HDD 305 of the multifunction device 120, and synchronized with the database on the management server 110. Here, only the process in the present embodiment will be described in the flowchart shown in FIGS. 7A and 7B.

In the present embodiment, the information denoting a type (category) of the setting value is added to the file of the job stored in step S702. The type of the setting value is information denoting the setting value modified and reflected regardless of the user (for example, the setting value concerning the device setting), or the setting value that is effective for the specific user only (the setting value concerning the user setting). Further, if the setting value that is effective for the specific user only is changed, the identification of the user is additionally included in the job.

In addition, in the present embodiment, a process similar to the process shown in FIG. 7B is further executed at the same timing. That is, two processes shown in FIG. 7B are executed at the same timing and they are different in the determination process in step S710. In step S710, one of the processes determines whether or not the setting value modified and reflected regardless of the user is stored as the job, and if the setting value is stored as the job (YES), the following process is performed.

The other one of the processes determines in step S710 whether or not the setting value that is effective for the specific user only is stored as the job, and if the setting value is stored as the job (YES), the following process is performed. Thus, a plurality of jobs corresponding to the different kinds of the setting values is executed at the same timing. It is noted that if there are a plurality of jobs corresponding to the same kind of the setting value, the jobs are sequentially executed.

If there is no dependence between the change of the setting value that is effective for the specific user only and the setting value modified and reflected regardless of the user, the above processes are performed, and therefore the prompt information transmission is enabled because the request of the change of the setting value to the management server can be performed at the same timing wherever possible.

As described above, according to the present embodiment, with the configuration described above, the setting value can be effectively managed between the multifunction device 120 and the management server 110 even if the setting reflected regardless of the user and the setting that is available by the specific user only are inconsistent.

### Other Embodiments

Embodiments of the present invention can also be realized by a computer of a system or device that reads out and executes computer executable instructions recorded on a storage medium (e.g., non-transitory computer-readable storage medium) to perform the functions of one or more of the above-described embodiment (s) of the present invention, and by a method performed by the computer of the system or device by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-266028, filed Dec. 24, 2013, which is hereby incorporated by reference herein in its entirety.

1. A network device communicating with a management server for managing master data of a setting value to be set in a plurality of network devices, the network device comprising:
a receiving unit configured to receive an instruction for a change of the setting value;
a storing unit configured to store a job generated for changing the setting value in a memory unit;
an executing unit configured to execute the change of the setting value according to the stored job in a database managed by the network device in response to a success of the storage of the job in the memory unit;
a request unit configured to request the management server to modify and reflect the change of the setting value according to the stored job in the master data if the job is stored in the memory unit; and
a notifying unit configured to notify the completion of the change of the setting value without waiting for a response from the management server based on the request in response to the completion of the change of the setting value by the executing unit.

2. The network device according to claim 1, wherein an inquiry whether or not the master data has been changed is executed to the management server, and
wherein if the master data is changed, the setting value corresponding to the change is obtained from the management server and reflected.

3. The network device according to claim 2, wherein the inquiry is periodically executed.

4. The network device according to claim 1, wherein the job stored in the memory unit is deleted in response to the success of the request by the request unit.

5. The network device according to claim 1, wherein the storage unit stores the generated job in the memory unit as the job that is different in each of categories of the setting value.

6. The network device according to claim 5, wherein the categories include a category including a setting value relating to a device setting and a category including a setting value relating to a user setting.

7. The network device according to claim 5, wherein the executing unit executes in parallel a plurality of jobs corresponding to the different categories and sequentially executes the jobs corresponding to a same category.

8. The network device according to claim 1, wherein the network devices are multifunction devices.

9. The network device according to claim 1,
wherein the request unit does not request the management server in a case where a start-up of a process or an end of a process of the network device is being performed.

10. The network device according to claim 1, wherein if the storage of the job in the memory unit is unsuccessful, the executing unit does not execute the change of the setting value.

11. A control method for a network device communicating with a management server for managing master data of a setting value to be set in a plurality of network devices, the method comprising:
receiving an instruction for a change of the setting value;
storing a job generated for changing the setting value in a memory unit;
executing the change of the setting value according to the stored job in a database managed by the network device in response to a success of the storage of the job in the memory unit;
requesting the management server to modify and reflect the change of the setting value according the stored job in the master data if the job is stored in the memory unit; and
notifying the completion of the change of the setting value without waiting for a response from the management server based on the request in response to the completion of the change of the setting value in the executing.

12. A non-transitory computer-readable storage medium storing a program for causing a computer to execute a controlling method executed in a network device communicating with a management server for managing master data of a setting value to be set in a plurality of network devices, the method comprising:
receiving an instruction for a change of the setting value;
storing a job generated for changing the setting value in a memory unit;
executing the change of the setting value according to the stored job in a database managed by the network device in response to a success of the storage of the job in the memory unit;
requesting the management server to modify and reflect the change of the setting value according the stored job in the master data if the job is stored in the memory unit; and
notifying the completion of the change of the setting value without waiting for a response from the management server based on the request in response to the completion of the change of the setting value in the executing.
